(19) United States
(12) Patent Application Publication
(10) Pub. No.: US 2005/0175085 A1
(43) Pub. Date: Aug. 11, 2005

(54) Method and apparatus for providing dentable encoding and encapsulation

(75) Inventors: James Russell Bergen, Hopewell, NJ (US); Michael Anthony Isnardi, Plainsboro, NJ (US); Christos Alkiviadis Polyzois, Lawrenceville, NJ (US)

Correspondence Address: MOSER, PATTERSON & SHERIDAN, LLP;/SARNOFF CORPORATION, 595 SHREWSBURY AVENUE, SUITE 100, SHREWSBURY, NJ, 07702, US

(73) Assignee: SARNOFF Corporation

(21) Appl. No.: 11/042,776

(22) Filed: Jan. 24, 2005

Related U.S. Application Data
(60) Provisional application No. 60/538,518, filed on Jan. 23, 2004.

(51) Int. Cl. H04N 7/12

(52) U.S. Cl. 375/240.01; 375/240; 375/240.26

(57) ABSTRACT

A method and apparatus for encoding a data sequence is disclosed. A data sequence is received. The data sequence is encoded such that the encoded data sequence comprises a plurality of data elements having assigned priorities. Data packets are generated using the encoded data sequence, where each data packet comprises only data elements of identical priority. The data packets are tagged with a priority descriptor indicating the priority of the data elements contained therein. Also disclosed is a method and apparatus for processing at least one packet. At least one packet is received, where each packet includes a priority descriptor that indicates a priority of at least one data element contained therein. Packets may then be selectively discarded based upon the priority descriptor.

### CROSS-REFERENCE TO RELATED APPLICATIONS

This application claims benefit of U.S. provisional patent application Ser. No. 60/538,518, filed Jan. 23 2004, which is herein incorporated by reference.

### BACKGROUND OF THE INVENTION

1. Field of the Invention

Embodiments of the present invention generally relate to broadband network architectures. More particularly, in one embodiment the present invention relates to video enhanced Asymmetric Digital Subscriber Line (ADSL) network architectures. Although the present invention is described in terminology used by the DSL Forum, the present invention can be adapted to other network architectures.

2. Description of the Related Art

Multiplexing multiple video streams to be carried in a single physical medium is a recurring problem in communications. The standard approach for analog systems is frequency division multiplexing such as is used in over-the-air broadcast television or analog cable systems. In these schemes the total bandwidth of the physical medium (e.g., cable system capacity) is divided into a set of fixed channels and one video stream is carried by each channel. This approach to multiplexing is very simple but it is not very efficient because each channel must be allocated bandwidth corresponding to the maximum required by the video stream that it carries even if that maximum is only occasionally realized. Plus, added efficiency of variable bit rate (VBR) video encoding over constant bit rate (CBR) encoding cannot be exploited in these systems. This inefficiency results from the need for fixed channel allocations. In packet switched environments such as IP and ATM networks multiple video streams can be combined in more flexible ways with packets representing different streams temporally multiplexed. This means that, in principle, variations in instantaneous video stream bit rate requirements can be exploited to reduce the total bandwidth required for a set of streams. This statistical multiplexing principle is used in some digital cable television system devices. These devices essentially receive multiple encoded video streams and create a multiplexed packet stream with total data rate lower than the sum of the inputs. A major drawback of this approach is processing complexity. These digital CATV devices must partially decode each input stream, perform the statistical multiplexing analysis and re-encode in order to achieve its benefit. This complexity can be supported in applications in which a small number of multiplexed streams will serve thousands or millions of viewers (such as in a cable system) but not in networked or on-demand applications in which customized multiplexing must be performed for single or small groups of recipients.

Therefore, there is a need in the art for a dentable encoding approach to achieve efficient statistical multiplexing.

### SUMMARY OF THE INVENTION

The present invention generally relates to a method and apparatus for encoding a data sequence. In one embodiment, a data sequence is received. The data sequence is encoded such that the encoded data sequence comprises a plurality of data elements having assigned priorities. Data packets are generated using the encoded data sequence, where each data packet comprises only data elements of identical priority. The data packets are tagged with a priority descriptor indicating the priority of the data elements contained therein.

Also disclosed is a method and apparatus for processing at least one packet. In one embodiment, at least one packet is received where each packet includes a priority descriptor that indicates a priority of at least one data element contained therein. Packets may then be selectively discarded based upon the priority descriptor.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates an Asymmetric Digital Subscriber Line (ADSL) video. application according to one embodiment of the present invention;

FIG. 2 illustrates a method for encoding a data sequence according to one embodiment of the present invention;

FIG. 3 illustrates a Tweening Based Coding approach according to one embodiment of the present invention;

FIG. 4 illustrates an example of prioritization of video information and tagging with a priority descriptor according to one embodiment of the present invention;

FIG. 5 illustrates an embodiment of the logical diagram of a DSLAM according to one embodiment of the present invention;

FIG. 6 illustrates a method for processing at least one packet according to one embodiment of the present invention;

FIG. 7 illustrates a block diagram of an image processing device or system according to one embodiment of the present invention

### DETAILED DESCRIPTION

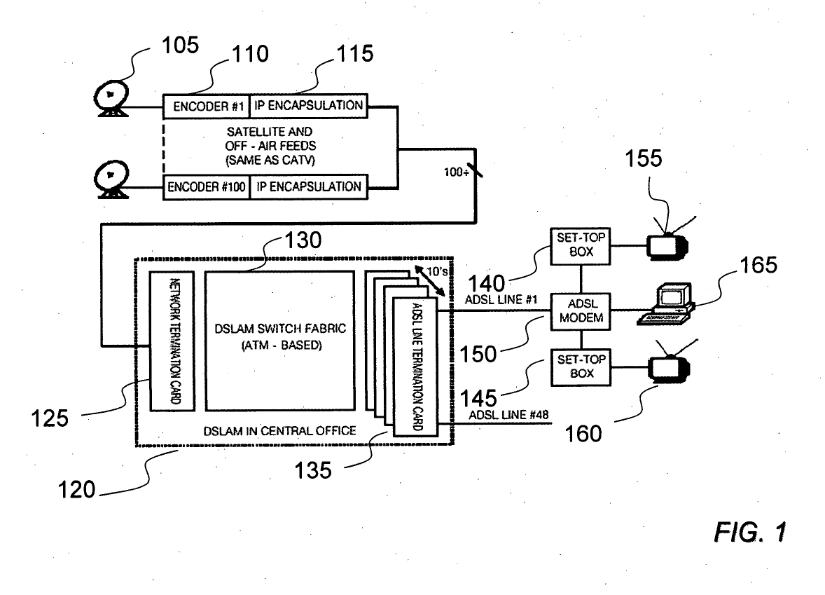

FIG. 1 illustrates one embodiment of an Asymmetric Digital Subscriber Line (ADSL) video application. As shown in FIG. 1, one or more satellites feed video data to one or more encoders 110. Once the plurality of video data is encoded this data is then encapsulated using encapsulator 115 and forwarded to Digital Subscriber Line Access Multiplexer (DSLAM) 120. DSLAM 120 comprises network termination card 125, switch 130, and line termination card 135. Switch 130 may be Asynchronous Transfer Mode (ATM) based. Line termination card 135 may be an ADSL line termination card. DSLAM 120 forwards the encoded frames to a modem 150 via an ADSL line. In one embodiment, modem 150 may be an Asymmetric Digital Subscriber Line (ADSL) device. Modem 150 forwards the encoded data to an end user device 155, 160, 165. The end user device may be either television 155, 160, computer 165, or any other device used in conjunction with ADSL. Users may be provided with their choice of a plurality of video streams from a large selection of programs. In one embodiment, set top boxes 140, 145 are each able to select and receive a video stream from a large selection of programs. At the same time, a user is able to use computer 165 for email access and web browsing.

The present invention provides, in one embodiment, a method and apparatus whereby selected streams are encoded, prioritized, and encapsulated using a dentable approach that allows efficient, high-quality multiplexing in a video aware DSLAM. In one embodiment, dentable encoding comprises information prioritization and priority metadata generation at the encoding stage, data segregation and priority tagging at the encapsulation stage, and a video aware switching element (e.g., router or DSLAM) at the multiplexing stage. In particular, in one embodiment, residential users have two TV sets that can independently select programs from satellite or off-air feeds via an ADSL modem. In addition, residential users may use a personal computer to access the internet via an ADSL modem.

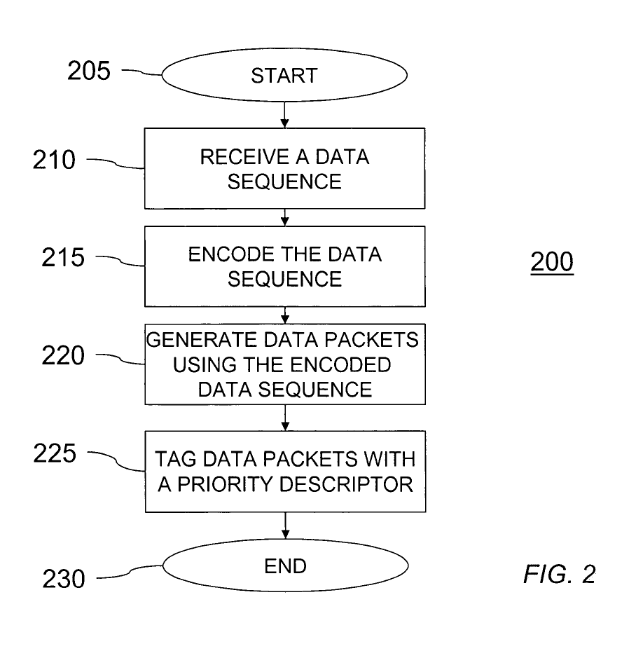

FIG. 2 illustrates a method 200 for encoding a data sequence according to one embodiment of the present invention. Method 200 begins in step 205 and proceeds to step 210. In step 210, a data sequence is received. In one embodiment, a plurality of data sequences may be received locally via camera, storage unit, or telecine feed. The plurality of image sequences may also be received via satellite feeds (e.g., satellite feed 105), cable, fiber, or off-air feeds. Each of the plurality of image sequences may comprise multiple pictures. If the received data is already in encoded format, it may proceed directly to step 220 if it is the required ADSL compression format.

In step 215 the data sequence is encoded. In one embodiment, encoder 110 encodes the plurality of image frames into a plurality of encoded frames in accordance with one embodiment of the present invention. Depending on various encoding standards, e.g., MPEG-2, MPEG-4, H.264/AVC and the like, various frames in an image sequence will be identified to be encoded as I-Frames, P-Frames, B-Frames, and the like. This identification of frame encoding may be referred to as information prioritization. The decision for encoding a frame as an I-Frame may be responsive to a number of conditions, e.g., maximal delay allowed for a scene change, a requirement dictated by a standard, e.g., length of a GOP and so on. Information prioritization refers to the ordering of encoded video information with respect to the severity of quality impairment in the decoded video stream resulting from loss or distortion of that portion of the signal. In the case of MPEG-2 encoded video, for example, I-frame information is high priority because loss of this information potentially creates a highly visible error in the decoded video that furthermore may persist for an extended time since the I-frame is used as the basis for prediction of an entire group of frames. Loss of P-frame or B-frame information generally has a less severe effect on output signal quality and thus is lower priority. MPEG and other video coding schemes can be made more robust with respect to random data loss by preferentially error protecting high priority data components. Once the information prioritization has occurred, priority metadata is generated based on the information prioritization information. In other words, a priority level is assigned to the frame.

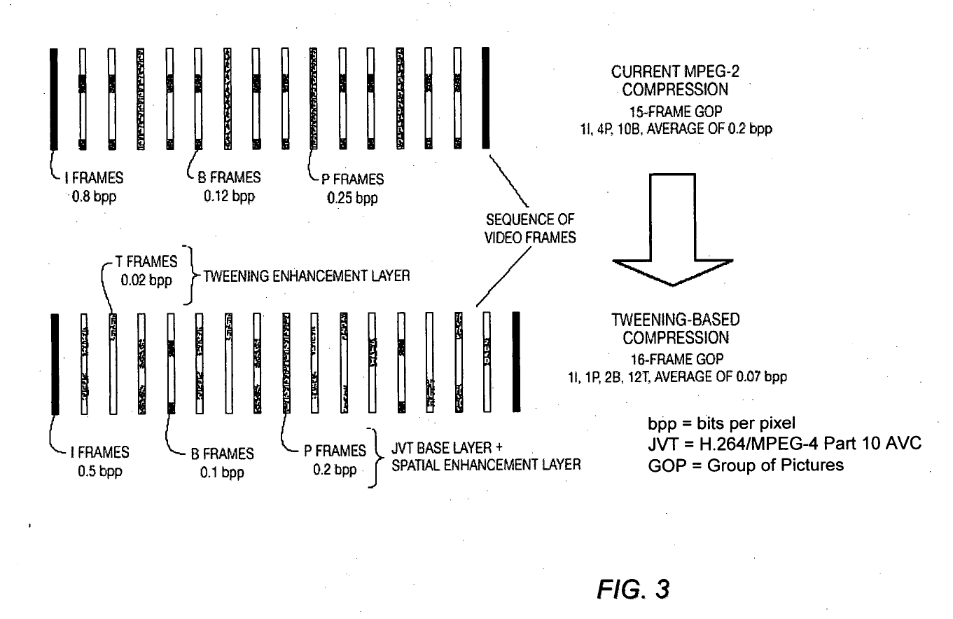

One coding approach that fits well with the dentable encoding structure is Tweening Based Coding which is illustrated in FIG. 3. In this scheme, a large proportion of the video frames (T-frames) are interpolated at the receiver using motion information that is implicitly coded. This means that dense interframe motion is computed at the receiver wherever the computation is accurate. The actual data transmitted for T-frames comprises guidance and correction information for this motion computation, and corrections to the interpolation in key areas. This T-frame information is ideal for dentable encoding because in the event that T-frame information is not available (e.g., T-frame information is discarded at the DSLAM), interpolation is performed using the information already at the receiver so that quality loss is minimized and does not propagate. In addition, Tweening Based Coding uses a 2-tier structure for coding I-, P-, and B-frames: a reduced spatial resolution base layer is robustly encoded with a spatial enhancement layer separately represented. This enhancement layer can also be selectively discarded as needed without severe or persistent loss in video quality.

In step 220, data packets are generated using the encoded data sequence. Dentable encoding builds on and extends the idea of prioritization by segregating data by priority level during the encapsulation process (e.g., data packet generation). Thus, individual data packets will contain data with a single (e.g., identical) priority level.

In step 225, the data packets are tagged with a priority descriptor (priority metadata) that identifies the priority level. The result of the packet generation and priority descriptor tagging process is a data stream that is “dentable” at the packet level. That is, selectively discarding a subset of the low priority packets will allow a video stream of known minimum quality to be decoded at the receiver. The motivation for the “dentable” description is that streams constructed in this way “dent” rather than break when squeezed. Thus, a video aware multiplexer when presented with two (or more) video streams with greater total instantaneous bandwith requirements than can be accommodated in the available channel can, by discarding only low priority packets, create a multiplexed stream with each component stream having a guaranteed minimum level of quality. The encoded pictures are then forwarded to a router or multiplexer. In one embodiment, the router or multiplexer may be Digital Subscriber Line Access Multiplexer (DSLAM) 120. In one embodiment, data packets are tagged with priority metadata (e.g. as part of a packet conversion process) at DSLAM 120.

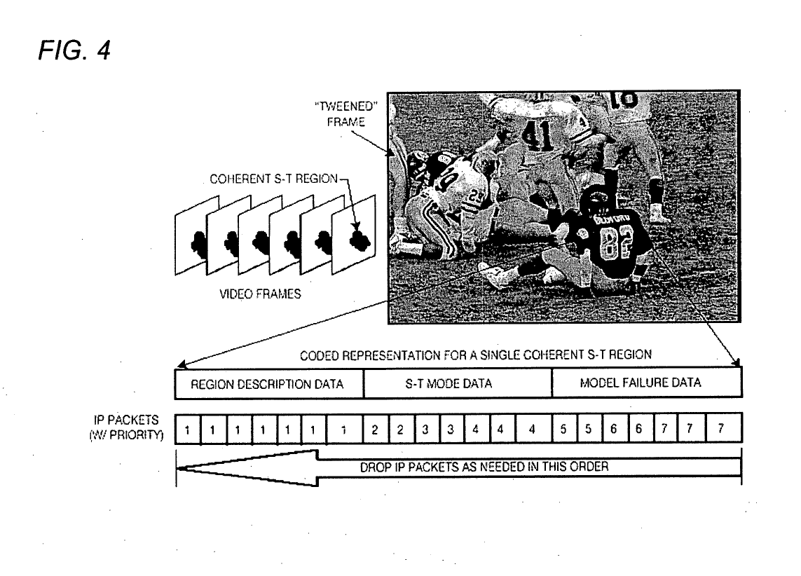

FIG. 4 illustrates an example of prioritization of video information and tagging with a priority descriptor. Prioritization of video information allows dentable encapsulation and intelligent packet discarding. The example in FIG. 4 illustrates the use of a tweening based encoding method with a coded representation for a single coherent spatio-temporal (S-T) region. The coded representation comprises regional description data, S-T mode data, and model failure data. In this embodiment, packets are discarded, as needed, from lowest priority to highest priority with “7” being low priority and “1” being high priority. A “coherent S-T region” is a volume of pixels in space and time that have similar attributes, such as color, texture and motion. When a coherent region is found, it does not need to be coded repeatedly in each video frame. Rather, its appearance throughout the spatio-temporal volume can be described by a smaller set of data, such as Region Description Data, S-T Mode Data, and corrective data called Model Failure Data. The auxiliary data that is used to represent the coherent S-T region is collectively called “tweening” data, in reference to the automatic filling-in of detail used in the animation industry.

For reasons of coding efficiency, “tweening” or temporal interpolation information is represented not for single video frames but for S-T regions corresponding to coherently transforming spatial structure. For example, a region such as the back of the jersey of the football player in the foreground will move coherently in the image as the camera pans or zooms (see FIG. 4). This coherent motion can be represented very efficiently for the entire S-T region (multiple frames) by describing the spatial and temporal extent and shape of the region, the functional form and parameters of the motion description (“S-T mode data”) and then supplying correction data (“model failure data”) where the parametric motion description does not represent the actual image change.

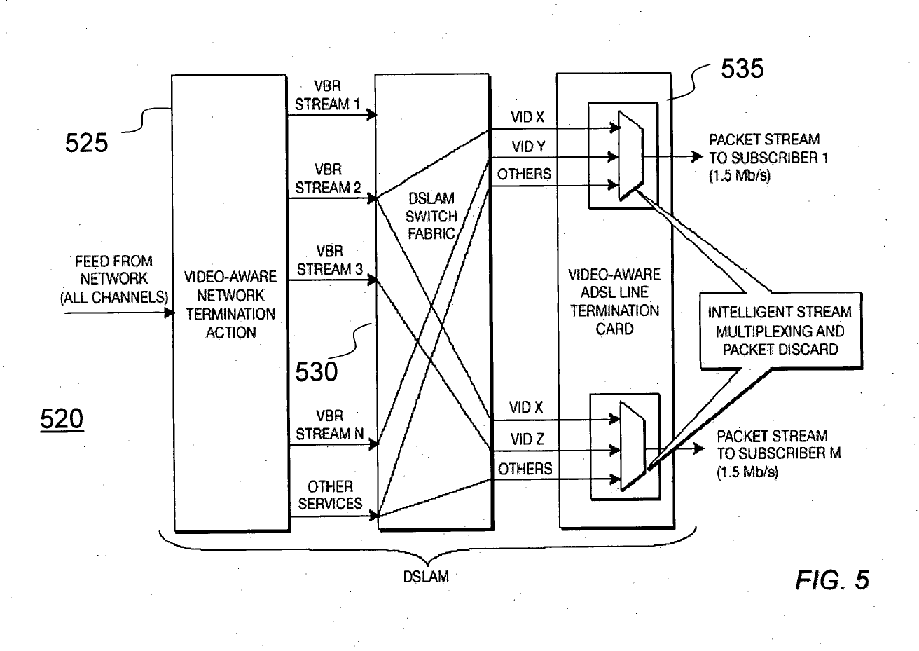

FIG. 5 illustrates one embodiment of the logical diagram of a DSLAM. DSLAM 520 comprises a network termination card 525. In one embodiment, the network termination card 525 comprises a video aware network termination card. DSLAM also comprises a switch 530 and a line termination card 535. In one embodiment, line termination card 535 comprises a video aware ADSL line termination card. In one embodiment, network termination card 525 receives one or more packets comprising one or more data segments. The data elements may comprise encoded video information or other information that may be provided to a subscriber. Each data packet comprises data elements of identical priority. Network termination card 525 provides a plurality of streams (e.g., variable bit rate (VBR) Streams 1 . . . N) and a feed for other services (e.g., internet access) to switch 530. Switch 530 provides one or more VBR streams and other services to a line termination card 535 for each subscriber. Packets from the one or more VBR streams and other services are selectively discarded according to priority level, as needed at line termination card 535. The DSLAM 520 then forwards the multiplexed VBR streams and other services to a subscriber using a packet stream. In one embodiment, the bandwidth available to forward information from the DSLAM is fixed.

In one embodiment, line termination card 535 uses its own buffers, traffic metadata and decoder (e.g., ADSL modem) buffer modeling to multiplex the VBR streams on each individual subscriber line in a way .that optimizes the visual benefit across all streams and minimizes the impact of discarded packets. In one embodiment, a buffer in an ADSL modem at a subscriber location may communicate buffer status to DSLAM 520.

In one embodiment, a video aware DSLAM may be utilized. In this embodiment, network termination card 525 examines the priority of the packets in the video feeds, performs the asynchronous transfer mode (ATM) adaptation and tags the resulting ATM cells with appropriate priority information. Network termination card 525 provides a plurality of streams (e.g., variable bit rate (VBR) Streams 1 . . . N) and a feed for other services (e.g., internet access) to switch 530. Switch 530 provides one or more VBR streams and other services to a line termination card 535 for each subscriber. Line termination card 535 uses its own buffers, traffic metadata, and potentially its decoder buffer modeling to multiplex the VBR streams on each individual subscriber line in a way that optimizes the visual benefit across all streams and minimizes the impact of discarded packets. In this embodiment, the subscriber selects from multiple available video streams and receives the selected streams over a DSL connection. Since the DSL line is a constant bandwidth channel, the selected streams must be multiplexed within this fixed bandwidth. Use of dentable encoding allows an “intelligent” multiplexing decision to be made very simply on a per-subscriber-line basis at the level of the inexpensive line termination card since all that is required is ordering by priority metadata tags. In this way a customized, optimally multiplexed stream can be provided to each subscriber without a significant increase in DSLAM cost.

In one embodiment, a video-aware Internet Protocol (IP) router is utilized. A video aware IP router maintains the quality of multiple video streams being delivered over an IP network by selectively discarding only low priority packets in response to conflicting bandwidth needs or in response to general congestion. As long as high priority packets are transmitted in a timely manner quality loss will not exceed a predictable limit. Furthermore, any lost quality will rapidly be restored as soon as conflict for the limited bandwidth resource eases.

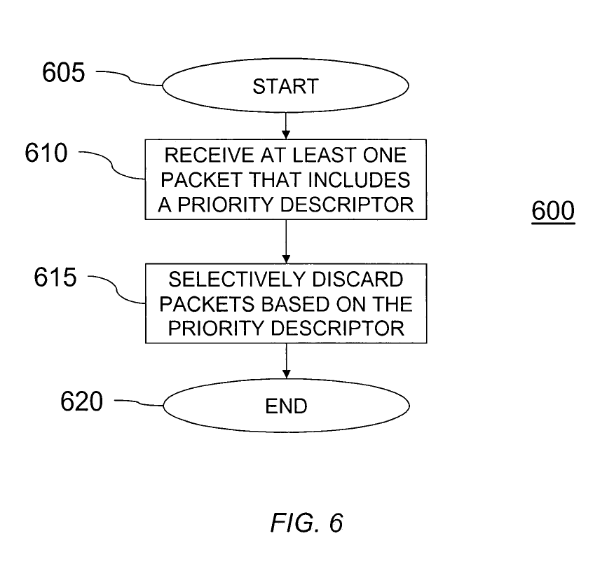

FIG. 6 illustrates a method 600 for processing at least one packet. Method 600 begins at step 605 and proceeds to step 610. In step 610 at least one packet is received at DSLAM 120. Each packet received at DSLAM 120 includes a priority descriptor that indicates a priority of at least one data element contained therein. Each packet comprises data elements of identical priority. In step 615, packets are selectively discarded based upon the priority descriptor. A packet stream is generated by DSLAM 120 from the undiscarded packets. The resulting packet stream is then forwarded to a subscriber e.g., via ADSL modem 150.

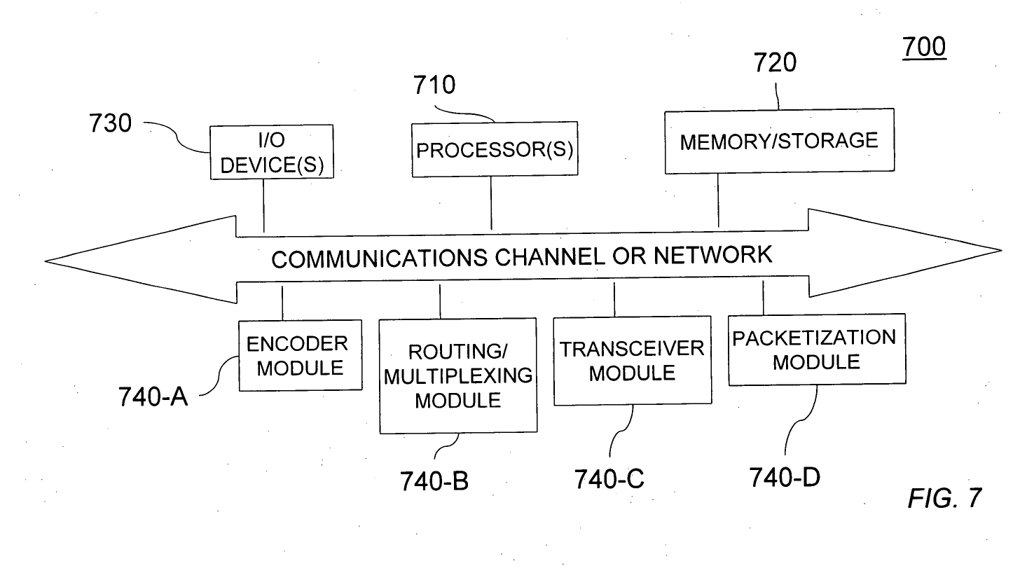

FIG. 7 illustrates a block diagram of an image processing device or system 700 of the present invention. Specifically, the system can be employed to provide dentable encoding and encapsulation. In one embodiment, the image processing device or system 700 is implemented using a general purpose computer or any other hardware equivalents.

Thus, image processing device or system 700 comprises a processor (CPU) 710, a memory 720, e.g., random access memory (RAM) and/or read only memory (ROM), an encoder module 740A, a routing/multiplexing module 740B, a transceiver module 740C, a packetization module 740D, and various input/output devices 730, (e.g., storage devices, including but not limited to, a tape drive, a floppy drive, a hard disk drive or a compact disk drive, a receiver, a transmitter, a speaker, a display, an image capturing sensor, e.g., those used in a digital still camera or digital video camera, a clock, an output port, a user input device (such as a keyboard, a keypad, a mouse, and the like, or a microphone for capturing speech commands).

It should be understood that the encoder module 740A, routing/multiplexing module 740B, transceiver module 740C, and packetization module 740D can be implemented as one or more physical devices that are coupled to the CPU 710 through a communication channel. Alternatively, the encoder module 740A, routing/multiplexing module 740B, transceiver module 740C, and packetization module 740D can be represented by one or more software applications (or even a combination of software and hardware, e.g., using application specific integrated circuits (ASIC)), where the software is loaded from a storage medium, (e.g., a magnetic or optical drive or diskette) and operated by the CPU in the memory 720 of the computer. As such, the encoder module 740A, routing module 740B, transceiver module 740C, and packetization module 740D (including associated data structures) of the present invention can be stored on a computer readable medium, e.g., RAM memory, magnetic or optical drive or diskette and the like. It should be apparent to one having skill in the art that encoder module 740A, routing module 740B, transceiver module 740C, and packetization module 740D, may, depending on the implementation, each have its own CPU, its own set of I/O devices, and its own memory. These modules may be physically separate devices connected together via a communications channel.

Dentable encoding can be used with any compression technique allowing information prioritization. This requires that 1) a signal can be reconstructed from a subset of the encoded packets, and 2) the information encoded can be ordered with respect to quality impact. Different coding techniques differ in how easily or effectively this can be done. For example MPEG-type coding can be used in a dentable approach if I-frame and motion information (high priority) is segregated from motion prediction residual information (low priority) and information is properly tagged and treated at the receiver, or if frames not used for prediction are tagged with lower priority. If only residual information is selectively discarded when necessary then the effect on reconstructed video quality will be limited in severity and duration.

Dentable encoding differs from more traditional layered coding techniques. In layered coding, a signal is represented as a relatively low quality core stream (the “base layer”) with one or more enhancement layers also available. The base layer is decodable by itself to produce a baseline quality result. If enhancement layers are also available then a higher quality signal can be reconstructed. A layered coding scheme allows different bandwidth versions of the same signal to be transmitted without re-encoding. However, layered coding does not allow small instantaneous adjustments to bit rate to be made. An enhancement layer may either be sent or not sent during a period of time but this provides rather coarse control of instantaneous bit rate. This means that if layered coding is used, large and abrupt variations in quality of one signal may occur in response to the varying bandwidth requirements of another signal in the same channel. Even a very small amount of contention for the fixed bandwidth resource can produce large variations in quality. In dentable encoding, in contrast, small variations in bandwidth requirements will produce at most only small variations in the rate of packet dropping with very small consequent variations in video quality.

Prioritization of critical data so that it can be more heavily error protected or redundantly represented is a technique that is used in various video coding schemes. Dentable encoding differs from these approaches in that the priority information is represented at the level of packets of metadata so that simple routing and switching elements can use the priority levels to make intelligent switching decisions without any increase in network element complexity or cost.

While the foregoing is directed to embodiments of the present invention, other and further embodiments of the invention may be devised without departing from the basic scope thereof, and the scope thereof is determined by the claims that follow.

1. A method for encoding a data sequence, comprising:
receiving said data sequence;
encoding the data sequence, said encoded data sequence comprising a plurality of data elements having assigned priorities;
generating data packets using the encoded data sequence, where each data packet comprises only data elements of identical priority; and
tagging the data packets with a priority descriptor indicating the priority of the data elements contained therein.

2. The method of claim 1, wherein encoding the data sequence comprises:
performing information prioritization; and
generating priority metadata based on said information prioritization.

3. The method of claim 1, further comprising forwarding the tagged data packets.

4. The method of claim 1, wherein the data sequence comprises a video sequence.

5. The method of claim 2, wherein performing information prioritization comprises performing tweening-based compression.

6. The method of claim 2, wherein performing information prioritization comprises performing MPEG-based compression.

7. An apparatus for encoding a data sequence, comprising:
means for receiving said data sequence;
means for encoding the data sequence, said encoded data sequence comprising a plurality of data elements having assigned priorities;
means for generating data packets using the encoded data sequence, where each data packet comprises only data elements of identical priority; and
means for tagging the data packets with a priority descriptor indicating the priority of the data elements contained therein.

8. The apparatus of claim 7, wherein means for encoding the data sequence comprises:
means for performing information prioritization; and
means for generating priority metadata based on said information prioritization.

9. The apparatus of claim 7, further comprising means for forwarding the tagged data packets.

10. The apparatus of claim 7, wherein the data sequence comprises a video sequence.

11. The apparatus of claim 8, wherein means for performing information prioritization comprises means for performing tweening-based compression.

12. The apparatus of claim 8, wherein means for performing information prioritization comprises means for performing MPEG-based compression.

13. A computer-readable medium having stored thereon a plurality of instructions, the plurality of instructions including instructions which, when executed by a processor, cause the processor to perform the steps of a method for encoding a data sequence, comprising:
receiving said data sequence;
encoding the data sequence, said encoded data sequence comprising a plurality of data elements having assigned priorities;
generating data packets using the encoded data sequence, where each data packet comprises only data elements of identical priority; and
tagging the data packets with a priority descriptor indicating the priority of the data elements contained therein.

14. A method for processing at least one packet, comprising:
receiving said at least one packet, each packet including a priority descriptor that indicates a priority of at least one data element contained therein; and
selectively discarding packets based upon the priority descriptor.

15. The method of claim 14, wherein said at least one packet contains only data elements having identical priority.

16. The method of claim 15, further comprising:
generating a packet stream from undiscarded packets; and
forwarding the packet stream.

17. An apparatus for processing at least one packet, comprising:
means for receiving said at least one packet, each packet including a priority descriptor that indicates a priority of at least one data element contained therein; and
means for selectively discarding packets based upon the priority descriptor.

18. The apparatus of claim 17, wherein said apparatus for processing at least one packet is aware of a receiver model of a user.

19. The apparatus of claim 17, wherein said at least one packet contains only data elements having identical priority.

20. A computer-readable medium having stored thereon a plurality of instructions, the plurality of instructions including instructions which, when executed by a processor, cause the processor to perform the steps of a method for processing at least one packet, comprising:
receiving said at least one packet, each packet including a priority descriptor that indicates a priority of at least one data element contained therein; and
selectively discarding packets based upon the priority descriptor.
